(19) United States
(12) Patent Application Publication
(10) Pub. No.: US 2024/0260786 A1
(43) Pub. Date: Aug. 8, 2024

(54) Cooking Utensil And Method Of Making The Same

(71) Applicant: All- Clad Metalcrafters LLC, Canonsburg, PA (US)

(72) Inventors: William A. Groll, McMurray, PA (US); Nicole Rae Christy, Wheeling, WV (US)

(73) Assignee: All- Clad Metalcrafters LLC, Canonsburg, PA (US)

(21) Appl. No.: 18/428,939

(22) Filed: Jan. 31, 2024

Related U.S. Application Data
(60) Provisional application No. 63/443,568, filed on Feb. 6, 2023.

(51) Int. Cl. A47J 36/02

(52) U.S. Cl. CPC A47J 36/025

(57) ABSTRACT

A method of making a cooking utensil and a cooking utensil made using the same are disclosed herein. In some embodiments, a method of making a cooking utensil includes applying pressure and heat to a multilayer stack to form a laminate, the multilayer stack including a metal substrate, a mesh layer, a first polymer film, and an additional layer having an opening therein, wherein the mesh layer, the first polymer film, and the additional layer are arranged on the same side of the metal substrate, and wherein the opening is sized such that the opening would surround the mesh layer if the additional layer and the mesh layer were disposed in the same plane.

### CROSS-REFERENCE TO RELATED APPLICATIONS

This application claims the benefit of the filing date of U.S. Provisional Patent Application No. 63/443,568 filed Feb. 6, 2023, the disclosure of which is hereby incorporated herein by reference.

### BACKGROUND

Some cooking utensils, such as frying pans and others, intended to be used on a cooking hob, or such as cooking parts of electrical cooking appliances, for instance cooking vats or cooking plates, require a non-stick surface to prevent food from sticking to the cooking surface. The non-stick surface is typically polytetrafluoroethylene (PTFE) or another type of polymer with non-stick properties. Non-stick surfaces are susceptible to scratching by knives, forks, metal spatulas, or other instruments used during cooking. Moreover, the non-stick surfaces, which are applied by a spray coating process, can be porous and uneven in thickness. For example, the non-stick surface can be applied after molding or shaping of the cooking utensil, and it is difficult to form an even coating in the corners of the interior surface of the cooking utensil. The spray coating process uses a solvent which then must be evaporated, which results in a porous non-stick coating. The porosity of the non-stick coating can result in grease, oil, and other food products being trapped in the pores of the non-stick coating, which results in loss of the non-stick property over time. Spray coating also introduces limitations in the thickness of the coating that can be applied. For example, a spray coating can typically be applied to a thickness of about 0.001 inches to about 0.002 inches. Further, when the spray coating is applied after shaping the cooking utensil which can result in an uneven distribution of coating, particularly in the corners and sidewalls of the cooking utensil.

Accordingly, there is a need in the art for a more robust non-sticking coating and method of making the same.

### BRIEF SUMMARY

A method of making a cooking utensil and a cooking utensil made using the same are disclosed herein. In some embodiments, the method includes applying pressure and heat to a multilayer stack to form a laminate, and then molding or shaping the laminate into a cooking utensil.

A first aspect of the present disclosure includes a method of making a cooking utensil comprising applying pressure and heat to a multilayer stack to form a laminate, the multilayer stack including a metal substrate, a mesh layer, a first polymer film, and an additional layer having an opening therein, wherein the mesh layer, the first polymer film, and the additional layer are arranged on the same side of the metal substrate, and wherein the opening is sized such that the opening would surround the mesh layer if the additional layer and the mesh layer were disposed in the same plane.

In another embodiment, the pressure may be applied in the direction of thickness of the stack. In another embodiment, the pressure may range from 300 bar to 1000 bar. In yet another embodiment, the temperature may range from 250 degrees Celsius to 500 degrees Celsius while the pressure is applied. In yet another embodiment, the pressure and heat may be applied for a period of about 10 minutes to about 180 minutes.

In yet another embodiment, the method further includes: preparing the first polymer film by a casting method, cutting method, calandering method, or an extrusion method; and then including the prepared first polymer film in the multilayer stack. In another embodiment, the cutting method may be a skiving method. In yet another embodiment of the first aspect, the first polymer film may be one or more selected from the group consisting of polytetrafluoroethylene (PTFE), tetrafluoroethylene-hexafluoropropylene copolymer (FEP), tetrafluoroethylene-perfluoroalkyl vinyl ether (PFA), ethylene-tetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE), ethylene-chlorotrifluoroethylene copolymer (ECTEF), PEEK, and PAEK family. In yet another embodiment, the first polymer film is a polytetrafluoroethylene (PTFE) film.

In another embodiment, a surface of the metal substrate facing an interior of the multilayer stack may be at least one of stainless steel, carbon steel, aluminum, or titanium. In another embodiment, the method includes shaping the laminate to form a cooking utensil. In another embodiment of the first aspect, the method includes cryogenically treating the laminate prior to shaping or the cooking utensil at temperatures of −73.3 degrees Celsius or less. In yet another embodiment, the method includes, prior to assembling the multilayer stack, pretreating a surface of the metal substrate facing an interior of the multilayer stack to form a texture on the surface. In another embodiment, the pretreatment method includes at least one of chemical etching, blasting, or belt sanding.

In yet another embodiment, the multilayer stack further comprises a second polymer film, wherein the second polymer film, the first polymer film, the mesh layer, and the additional layer are arranged on the same side of the metal substrate. In yet another embodiment, the second polymer film comprises one or more selected from the group consisting of polytetrafluoroethylene (PTFE), tetrafluoroethylene-hexafluoropropylene copolymer (FEP), tetrafluoroethylene-perfluoroalkyl vinyl ether (PFA), ethylene-tetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE), ethylene-chlorotrifluoroethylene copolymer (ECTEF), PEEK, and PAEK family. In yet another embodiment, the second polymer film is a polytetrafluoroethylene (PTFE) film. In yet another embodiment, where the multilayer stack is arranged in the following sequence: the metal substrate, the first polymer film overlying the metal substrate, the mesh layer and the additional layer overlying the first polymer film, and the second polymer film overlying the mesh layer and the additional layer, wherein the mesh layer and the additional layer having the opening are disposed in the same plane.

In yet another embodiment, the thicknesses of the first polymer film, the second polymer film, the additional layer, and the mesh layer have the following relationship, the laminate has the mesh layer at least in contact with the metal substrate on one side thereof and has the mesh layer exposed through the second polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} = {T}_{T} + {T}_{B} \qquad ( 3 )$$

$${T}_{D} = {T}_{M} - {T}_{F} \qquad ( 4 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within a volume of the mesh layer having surface area A and thickness T_{M}, and T_{F} is a thickness of a polymer film need to fill the volume of void space within the mesh layer having surface area A and thickness T_{M}, T_{D} is a thickness of the additional layer having the opening, T_{B} is the thickness of the first polymer film, and T_{T} is the thickness of the second polymer film.

In yet another embodiment, when the thicknesses of the first polymer film, the second polymer film, the additional layer, and the mesh layer have the following relationship, the laminate has the mesh layer not being in contact with the metal substrate on one side thereof and has the mesh layer exposed through the second polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{FNo} = C \times {T}_{F} = {T}_{T} + {T}_{B} , C > 1 , {T}_{B} \geq {T}_{T} \qquad ( 4 )$$

$${T}_{D} = {T}_{M} - {T}_{FNo} \qquad ( 5 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having area A and thickness T_{M}, V is a ratio of volume of void space within a volume of the mesh layer having surface area A and thickness T_{M}, and T_{F} is a thickness of a polymer film need to fill the volume of void space within of the mesh layer having surface area A and thickness T_{M}, T_{FNo} is a thickness of a polymer film need to fill the volume of void space and also ensure that the mesh layer does not contact the metal substrate, T_{D} is a thickness of the additional layer having the opening, T_{B} is the thickness of the first polymer film, and T_{T} is the thickness of the second polymer film. In yet another embodiment, C may range from 1.1 to 1.5.

In yet another embodiment, the additional layer is a polymer film, a metal, or a non-polymer.

In yet another embodiment, the multilayer stack is arranged in the following sequence: the metal substrate, the first polymer film overlying the metal substrate, the mesh layer overlying the first polymer film, the second polymer film overlying the mesh layer, and the additional layer overlying the second polymer film.

In yet another embodiment, when the thicknesses of the first polymer film, the second polymer film, the additional layer, and the mesh layer have the following relationship, the laminate has the mesh layer at least in contact with the metal substrate on one side thereof and has the mesh layer exposed through the second polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} = {T}_{T} + {T}_{B} \qquad ( 3 )$$

$${T}_{D} = {T}_{M} - {T}_{F} \qquad ( 4 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within a volume of the mesh layer having surface area A and thickness T_{M}, and T_{F} is a thickness of a polymer film need to fill the volume of void space within the mesh layer having surface area A and thickness T_{M}, T_{D} is a thickness of the additional layer having the opening, T_{B} is the thickness of the first polymer film, and T_{T} is the thickness of the second polymer film.

In yet another embodiment, when the thicknesses of the first polymer film, the second polymer film, the additional layer, and the mesh layer have the following relationship, the laminate has the mesh layer not being in contact with the metal substrate on one side thereof and has the mesh layer exposed through the second polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{FNo} = C \times {T}_{F} = {T}_{T} + {T}_{B} , C > 1 , {T}_{B} \geq {T}_{T} \qquad ( 4 )$$

$${T}_{D} = {T}_{M} - {T}_{FNo} \qquad ( 5 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of the mesh layer having surface area A and thickness T_{M}, and T_{F} is a thickness of a polymer film need to fill the volume of void space within the mesh layer having surface area A and thickness T_{M}, T_{FNo} is a thickness of a polymer film need to fill the volume of void space and also ensure that the mesh layer does not contact the metal substrate, T_{D} is a thickness of the additional layer having the opening, T_{B} is the thickness of the first polymer film, and T_{T} is the thickness of the second polymer film. In yet another embodiment of the first aspect, C ranges from 1.1 to 1.5.

In yet another embodiment, the additional layer comprises a material that does not laminate with the multilayer stack or a polymer material that laminates with the multilayer stack. In yet another embodiment, the additional layer having the opening comprises a material that does not laminate with the multilayer stack, the method further includes removing the additional layer having the opening from the laminate and shaping the laminate into a cooking utensil. In yet another embodiment, the additional layer having the opening comprises a material that laminates with the multilayer stack, the method further includes shaping the laminate into a cooking utensil.

In yet another embodiment, the multilayer stack is arranged in the following sequence: the metal substrate, the first polymer film overlying the metal substrate, the mesh layer and the additional layer having the opening overlying the first polymer film, wherein the mesh layer and the layer having the opening are disposed in the same plane. In yet another embodiment, when the thicknesses of the first polymer film, the additional layer, and the mesh layer have the following relationship, the laminate has the mesh layer at least in contact with the metal substrate on one side thereof and has the mesh layer exposed through the first polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{D} = {T}_{M} - {T}_{F} \qquad ( 4 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of the mesh layer having surface area A and thickness T_{M}, and T_{F} is a thickness of the first polymer film need to fill the volume of void space within the mesh layer having surface area A and thickness T_{M}, and T_{D} is a thickness of the additional layer having the opening.

In yet another embodiment, when the thicknesses of the first polymer film, the additional layer, and the mesh layer have the following relationship, the laminate has the mesh layer not being in contact with the metal substrate on one side thereof and has the mesh layer exposed through the second polymer film:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{F n o} = C \times {T}_{F} , C > 1 \qquad ( 4 )$$

$${T}_{D} = {T}_{M} - {T}_{FNo} \qquad ( 5 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of mesh layer having surface area A and thickness T_{M}, and T_{F} is a thickness of a polymer film need to fill the void space within the mesh layer having surface area A and thickness T_{M}, T_{FNo} is a thickness of the first polymer film need to fill the volume of void space and also ensure that the mesh layer does not contact the metal substrate, and T_{D} is a thickness of the additional layer having the opening. In yet another embodiment of the first aspect, C may range from 1.1 to 1.5.

In yet another embodiment, the additional layer comprises a material that does not laminate with the multilayer stack or a polymer material that laminates with the multilayer stack. In yet another embodiment, the multilayer stack is arranged in the following sequence: the metal substrate, the mesh layer and the additional layer overlying the metal substrate, and the first polymer film overlying the mesh layer and the additional layer having the opening, wherein the mesh layer and the additional layer having the opening are disposed in the same plane.

In yet another embodiment, when the thicknesses of the first polymer film, the additional layer, and the mesh layer have the following relationship, the laminate has the mesh layer at least in contact with the metal substrate on one side thereof and has the mesh layer exposed through the first polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{D} = {T}_{M} - {T}_{F} \qquad ( 4 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of mesh layer having surface area A and thickness T_{M}, and T_{F} is a thickness of the first polymer film need to fill the volume of void space within the mesh layer having surface area A and thickness T_{M}, and T_{D} is a thickness of the additional layer having the opening.

In yet another embodiment, when the thicknesses of the first polymer film, the second polymer film, the additional layer, and the mesh layer have the following relationship, the laminate has the mesh layer not being in contact with the metal substrate on one side thereof and has the mesh layer exposed through the second polymer film:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{F N o} = C \times {T}_{F} , C > 1 \qquad ( 4 )$$

$${T}_{D} = {T}_{M} - {T}_{F N o} \qquad ( 5 )$$

wherein A is surface area of the mesh layer, T_{M} is thickness of the mesh layer in a horizontal plane that is perpendicular to a thickness direction of the multilayer stack, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of mesh layer having surface area A and thickness T_{M}, and T_{F} is a thickness of a polymer film need to fill the volume of void space within the mesh layer having surface area A and thickness T_{M}, T_{FNo} is a thickness of the first polymer film need to fill the volume of void space and also ensure that the mesh layer does not contact the metal substrate, and T_{D} is a thickness of the additional layer having the opening. In yet another embodiment, C may range from 1.1 to 1.5.

In yet another embodiment, the additional layer comprises a polymer, a metal, or a non-metal.

In yet another embodiment, the multilayer stack is arranged in the following sequence: the metal substrate, the mesh layer overlying the metal substrate, the first polymer film overlying the mesh layer, the additional layer having the opening overlying the first polymer film. In yet another embodiment of the first aspect, when the thicknesses of the first polymer film, the additional layer, and the mesh layer have the following relationship, the laminate has the mesh layer at least in contact with the metal substrate on one side thereof and has the mesh layer exposed through the first polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{D} = {T}_{M} - {T}_{F} \qquad ( 4 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of mesh layer having surface area A and thickness T_{M}, and T_{F} is a thickness of the first polymer film need to fill the volume of void space within the mesh layer having surface area A and thickness T_{M}, and T_{D} is a thickness of the additional layer having the opening.

In yet another embodiment, when the thicknesses of the first polymer film, the additional layer, and the mesh layer have the following relationship, the laminate has the mesh layer not being in contact with the metal substrate on one side thereof and has the mesh layer exposed through the second polymer film:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{F N o} = C \times {T}_{F} , C > 1 \qquad ( 4 )$$

$${T}_{D} = {T}_{M} - {T}_{F N o} \qquad ( 5 )$$

wherein A is surface area of the mesh layer, T_{M} is thickness of the mesh layer in a horizontal plane that is perpendicular to a thickness direction of the multilayer stack, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of the mesh layer having surface area A and thickness T_{M}, and T_{F} is a thickness of a polymer film need to fill the volume of void space within the mesh layer having surface area A and thickness T_{M}, T_{FNo} is a thickness of the first polymer film need to fill the void space and also ensure that the mesh layer does not contact the metal substrate, and T_{D} is a thickness of the additional layer having the opening. In yet another embodiment, C may range from 1.1 to 1.5. In yet another embodiment, the additional layer comprises a material that does not laminate with the multilayer stack or a polymer material that laminates with the multilayer stack.

In a second aspect, the present disclosure relates to a method of making a cooking utensil comprising applying pressure and heat to a multilayer stack to form a laminate, the multilayer stack including a metal substrate having a notch, a mesh layer aligned with the notch such that the mesh layer is surrounded by the notch upon lamination, and a first polymer film, wherein the mesh layer and the first polymer film are arranged on the same side of the metal substrate.

In another embodiment of the second aspect, the first polymer film includes one or more selected from the group consisting of polytetrafluoroethylene (PTFE), tetrafluoroethylene-hexafluoropropylene copolymer (FEP), tetrafluoroethylene-perfluoroalkyl vinyl ether (PFA), ethylene-tetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE), ethylene-chlorotrifluoroethylene copolymer (ECTEF), PEEK, and PAEK family. In yet another embodiment, first polymer film is a polytetrafluoroethylene (PTFE) film. In yet another embodiment, a surface of the metal substrate facing an interior of the multilayer stack comprises at least one of stainless steel, carbon steel, aluminum, or titanium. In yet another embodiment, the mesh layer does not contact the metal layer at the bottom of the notch. In yet another embodiment, the mesh layer contacts the metal layer at the bottom of the notch. In yet another embodiment, the mesh layer is partially embedded in the metal layer at the bottom of the notch.

In yet another embodiment, the multilayer stack is arranged in the following sequence: the metal substrate, the mesh layer overlying the metal substrate, and the first polymer film overlying the mesh layer. In yet another embodiment, when the thicknesses of the first polymer film, the notch, and the mesh layer have the following relationship, the laminate has the mesh layer at least in contact with the metal substrate on one side thereof and has the mesh layer exposed through the first polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{N} = {T}_{M} - {T}_{F} \qquad ( 4 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of the mesh layer having surface area A and thickness T_{M}, and T_{F} is a thickness of the first polymer film need to fill the volume of void space within the boundary of the mesh layer having surface area A and thickness T_{M}, and T_{N} is a thickness of the notch.

In yet another embodiment, when the thicknesses of the first polymer film, the notch, and the mesh layer have the following relationship, the laminate has the mesh layer not being in contact with the metal substrate on one side thereof and has the mesh layer exposed through the second polymer film:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{F N o} = C \times {T}_{F} , C > 1 \qquad ( 4 )$$

$${T}_{N} = {T}_{M} - {T}_{F N o} \qquad ( 5 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of the mesh layer having surface area A and thickness T_{M}, and T_{F} is a thickness of a polymer film need to fill the void space within the mesh layer having surface area A and thickness T_{M}, T_{FNo} is a thickness of the first polymer film need to fill the volume of void space and also ensure that the mesh layer does not contact the metal substrate, and T_{N} is a thickness of the notch.

In yet another embodiment, the multilayer stack is arranged in the following sequence: the metal substrate, the first polymer film overlying the metal substrate, and mesh layer overlying the first polymer. In yet another embodiment, when the thicknesses of the first polymer film, the notch, and the mesh layer have the following relationship, the laminate has the mesh layer at least in contact with the metal substrate on one side thereof and has the mesh layer exposed through the first polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{N} = {T}_{M} - {T}_{F} \qquad ( 4 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of the mesh layer having surface area A and thickness T_{M}, and T_{F} is a thickness of the first polymer film need to fill the volume of void space within the mesh layer having surface area A and thickness T_{M}, and T_{N} is a thickness of the notch.

In yet another embodiment, when the thicknesses of the first polymer film, the notch, and the mesh layer have the following relationship, the laminate has the mesh layer not being in contact with the metal substrate on one side thereof and has the mesh layer exposed through the second polymer film:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{F N o} = C \times {T}_{F} , C > 1 \qquad ( 4 )$$

$${T}_{N} = {T}_{M} - {T}_{F N o} \qquad ( 5 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of the mesh layer having surface area A and thickness T_{M}, and T_{F} is a thickness of a polymer film need to fill the volume of void space within the mesh layer having surface area A and thickness T_{M}, T_{FNo} is a thickness of the first polymer film need to fill the volume of void space and also ensure that the mesh layer does not contact the metal substrate, and T_{N} is a thickness of the notch. In yet another embodiment, C may range from 1.1 to 1.5.

In yet another embodiment, the multilayer stack further comprises a second polymer film, and the multilayer stack is arranged in the following sequence: the metal substrate, the first polymer film overlying the metal substrate, and mesh layer overlying the first polymer, and the second polymer film overlying the mesh layer. In yet another embodiment, when the thicknesses of the first polymer film, the second polymer film, the notch, and the mesh layer have the following relationship, the laminate has the mesh layer at least in contact with the metal substrate on one side thereof and has the mesh layer exposed through the second polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} = {T}_{T} + {T}_{B} \qquad ( 3 )$$

$${T}_{N} = {T}_{M} - {T}_{F} \qquad ( 4 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of the mesh layer having surface area A and thickness T_{M}, and T_{F} is a thickness of a polymer film need to fill the volume of void space within the mesh layer having surface area A and thickness T_{M}, T_{N} is a thickness of the notch, T_{B} is the thickness of the first polymer film, and Tris the thickness of the second polymer film.

In yet another embodiment, when the thicknesses of the first polymer film, the second polymer film, the notch, and the mesh layer have the following relationship, the laminate has the mesh layer not being in contact with the metal substrate on one side thereof and has the mesh layer exposed through the second polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{F N o} = C \times {T}_{F} = {T}_{T} + {T}_{B} , C > 1 , {T}_{B} \geq {T}_{T} \qquad ( 4 )$$

$${T}_{N} = {T}_{M} - {T}_{F N o} \qquad ( 5 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of the mesh layer having surface area A and thickness T_{M}, and T_{F} is a thickness of a polymer film need to fill the volume of void space within the mesh layer having surface area A and thickness T_{M}, T_{FNo} is a thickness of a polymer film need to fill the volume of void space and also ensure that the mesh layer does not contact the metal substrate, T_{N} is a thickness of the notch, T_{B} is the thickness of the first polymer film, and Tris the thickness of the second polymer film. In yet another embodiment, C may range from 1.1 to 1.5. In yet another embodiment, the first polymer film may be aligned with the mesh layer and with the notch, wherein first polymer film may be sized such that the first polymer film is capable of being disposed within the notch.

In a third aspect, a method of making a cooking utensil includes applying pressure and heat to a multilayer stack to form a laminate, the multilayer stack arranged in the following sequence: a metal substrate, a first polymer film overlying the metal substrate, a mesh layer overlying the first polymer film, a second polymer film overlying the mesh layer, wherein the peripheral edges of the metal substrate, mesh layer, and first and second polymer films align.

In another embodiment of the third aspect, the first and second polymer films, independently, comprises one or more selected from the group consisting of polytetrafluorocthylene (PTFE), tetrafluoroethylene-hexafluoropropylene copolymer (FEP), tetrafluorocthylene-perfluoroalkyl vinyl ether (PFA), ethylene-tetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE), ethylene-chlorotrifluoroethylene copolymer (ECTEF), PEEK, and PAEK family. In yet another embodiment, the first and second polymer films may be polytetrafluoroethylene (PTFE) films. In yet another embodiment, a surface of the metal substrate facing an interior of the multilayer stack comprises at least one of stainless steel, carbon steel, aluminum, or titanium.

In another embodiment, when the thicknesses of the first polymer film, the second polymer film, and the mesh layer have the following relationship, the laminate has the mesh layer at least in contact with the metal substrate on one side thereof and has the mesh layer exposed through the second polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} = {T}_{T} + {T}_{B} \qquad ( 3 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of the mesh layer having surface area A and thickness T_{M}, and T_{F} is a thickness of a polymer film need to fill the volume of void space within the mesh layer having surface area A and thickness T_{M}, T_{B} is the thickness of the first polymer film, and Tris the thickness of the second polymer film.

In yet another embodiment, when the thicknesses of the first polymer film, the second polymer film, and the mesh layer have the following relationship, the laminate has the mesh layer not being in contact with the metal substrate on one side thereof and has the mesh layer exposed through the second polymer film on an opposite side thereof:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

$${T}_{F N o} = C \times {T}_{F} = {T}_{T} + {T}_{B} , C > 1 , {T}_{B} \geq {T}_{T} \qquad ( 4 )$$

wherein A is surface area of the mesh layer in a horizontal plane that is perpendicular to a thickness direction of the multilayer stack, T_{M} is thickness of the mesh layer, d_{M} is density of the material used in the mesh layer, W₁ is weight of the mesh layer having surface area A and thickness Tₘ, W₂ is weight of a solid layer of the mesh material having surface area A and thickness T_{M}, V is a ratio of volume of void space within the volume of the mesh layer having surface area A and thickness T_{M}, and T_{F} is a thickness of a polymer film need to fill the volume of void space within the mesh layer having surface area A and thickness T_{M}, T_{FNo} is a thickness of a polymer film need to fill the volume of void space and also ensure that the mesh layer does not contact the metal substrate, T_{B} is the thickness of the first polymer film, and T_{T} is the thickness of the second polymer film. In yet another embodiment, C may range from 1.1 to 1.5.

In a fourth aspect, a cooking utensil includes a laminate comprising a metal layer, a mesh layer, and a polymer film, where in the mesh layer is embedded in the polymer film, wherein the laminate is shaped to have a cooking surface and a sidewall surface surrounding the periphery of the cooking surface, wherein the sidewall surface extends from the periphery of the cooking surface to an outer edge of the laminate, wherein the mesh layer extends along at least a portion of the sidewall surface, and wherein a portion of the mesh layer is exposed on the cooking surface and on at least a portion of the sidewall surface.

In another embodiment of the fourth aspect, the mesh layer does not contact the metal layer. In yet another embodiment, the mesh layer contacts the metal layer. In yet another embodiment, the mesh layer is partially embedded in the metal layer. In yet another embodiment, the metal layer further includes a notched portion having the mesh layer disposed therein. In yet another embodiment, the mesh layer extends along the entire sidewall surface, and where a portion of the mesh is exposed on the sidewall surface. In yet another embodiment, the outer edge of the laminate is covered by a cap. In yet another embodiment, the mesh layer does not contact the metal layer. In yet another embodiment, the mesh layer contacts the metal layer. In yet another embodiment, the mesh layer is partially embedded in the metal layer.

In yet another embodiment, the polymer film comprises one or more selected from the group consisting of polytetrafluoroethylene (PTFE), tetrafluoroethylene-hexafluoropropylene copolymer (FEP), tetrafluorocthylene-perfluoroalkyl vinyl ether (PFA), ethylene-tetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluorocthylene-perfluoromethyl vinyl ether copolymer (PFE/PMVE) and ethylene-chlorotrifluoroethylene copolymer (ECTEF), PEEK, and PAEK family. In yet another embodiment, the polymer film is a polytetrafluoroethylene (PTFE) film. In yet another embodiment, a surface of the metal substrate facing an interior of the multilayer stack comprises at least one of stainless steel, carbon steel, aluminum, or titanium.

In a fifth aspect, a cooking utensil includes a laminate comprising a metal layer, a mesh layer, and a polymer film, where in the mesh layer is embedded in the polymer film, wherein the metal layer includes a notch, wherein the mesh layer is disposed in the notch, wherein the laminate is shaped to have a cooking surface and a sidewall surface surrounding the periphery of the cooking surface, wherein the sidewall surface extends from the periphery of the cooking surface to an outer edge of the laminate, wherein a portion of the mesh layer is exposed on the cooking surface.

In another embodiment of the fifth aspect, the mesh layer does not extend along the sidewall surface. In yet another embodiment, the mesh layer extends along at least a portion of the sidewall surface and is exposed on the at least a portion of the sidewall surface. In yet another embodiment, the polymer film comprises one or more selected from the group consisting of polytetrafluoroethylene (PTFE), tetrafluoroethylene-hexafluoropropylene copolymer (FEP), tetrafluoroethylene-perfluoroalkyl vinyl ether (PFA), ethylene-tetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE), ethylene-chlorotrifluoroethylene copolymer (ECTEF), PEEK, and PAEK family. In yet another embodiment, the polymer film is a polytetrafluoroethylene (PTFE) film. In yet another embodiment, a surface of the metal substrate facing an interior of the multilayer stack comprises at least one of stainless steel, carbon steel, aluminum, or titanium.

A sixth aspect of the present disclosure, a cooking utensil includes a laminate comprising a metal layer, a mesh layer, an additional layer, and a first polymer film and a second polymer film, wherein the additional layer has an opening, wherein the opening surrounds the mesh layer, wherein the mesh layer and the additional layer are disposed between the first and second polymer films, wherein the additional layer is a metal or a non-polymer, wherein the first polymer film and second polymer film contact each other through the mesh layer, wherein the laminate is shaped to have a cooking surface and a sidewall surface surrounding the periphery of the cooking surface, wherein the sidewall surface extends from the periphery of the cooking surface to an outer edge of the laminate, wherein a portion of the mesh layer is exposed on the cooking surface.

In another embodiment of the sixth aspect, the first and second polymer films include one or more selected from the group consisting of polytetrafluoroethylene (PTFE), tetrafluoroethylene-hexafluoropropylene copolymer (FEP), tetrafluoroethylene-perfluoroalkyl vinyl ether (PFA), ethylene-tetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE), ethylene-chlorotrifluoroethylene copolymer (ECTEF), PEEK, and PAEK family. In yet another embodiment of the sixth aspect, the first and second polymer films are polytetrafluoroethylene (PTFE) films. In yet another embodiment, a surface of the metal substrate facing an interior of the multilayer stack includes at least one of stainless steel, carbon steel, aluminum, or titanium. In yet another embodiment, the mesh layer does not contact the metal layer. In yet another embodiment, the mesh layer contacts the metal layer. In yet another embodiment, the mesh layer is partially embedded in the metal layer.

### BRIEF DESCRIPTION OF THE DRAWINGS

FIG. 1A is a schematic cross-sectional view of a cooking utensil formed from a multilayer laminate in accordance with some embodiments of the present disclosure.

FIG. 1B is a photograph of a cooking surface in accordance with some embodiments of the present disclosure.

FIG. 1C is a schematic cross-sectional view of a cooking utensil formed from a multilayer laminate in accordance with some embodiments of the present disclosure.

FIG. 1D is a schematic cross-sectional view of a cooking utensil formed from a multilayer laminate in accordance with some embodiments of the present disclosure.

FIG. 1E is a schematic cross-sectional and exploded view of a cooking utensil formed from a multilayer laminate in accordance with some embodiments of the present disclosure.

FIG. 1F is a schematic cross-sectional view of a cooking utensil formed from a multilayer laminate in accordance with some embodiments of the present disclosure.

FIG. 1G is a schematic cross-sectional view of a cooking utensil formed from a multilayer laminate in accordance with some embodiments of the present disclosure.

FIG. 1H is a schematic cross-sectional view of a cooking utensil formed from a multilayer laminate in accordance with some embodiments of the present disclosure.

FIG. 2A is a schematic cross-sectional view of an unlaminated multilayer stack in accordance with some embodiments of the present disclosure.

FIG. 2B is a schematic cross-sectional view of an unlaminated multilayer stack in accordance with some embodiments of the present disclosure.

FIG. 2C is a schematic cross-sectional view of an unlaminated multilayer stack in accordance with some embodiments of the present disclosure.

FIG. 2D is a schematic cross-sectional view of a unlaminated multilayer stack in accordance with some embodiments of the present disclosure.

FIG. 2E is a schematic cross-sectional view of an unlaminated multilayer stack in accordance with some embodiments of the present disclosure.

FIG. 2F is a schematic cross-sectional view of an unlaminated multilayer stack in accordance with some embodiments of the present disclosure.

FIG. 3A is a schematic cross-sectional and exploded view of an unlaminated multilayer stack in accordance with some embodiments of the present disclosure.

FIG. 3B is a schematic cross-sectional and exploded view of an unlaminated multilayer stack in accordance with some embodiments of the present disclosure.

FIG. 3C is a schematic cross-sectional and exploded view of an unlaminated multilayer stack in accordance with some embodiments of the present disclosure.

FIG. 3D is a schematic cross-sectional and exploded view of an unlaminated multilayer stack in accordance with some embodiments of the present disclosure.

FIG. 4 is a simplified side elevational view of a pressing fixture for use in a method of the present disclosure.

FIG. 5 is an image of a laminated multilayer stack in accordance with the Example.

FIG. 6 is an image of a laminated multilayer stack in accordance with the Comparative Example.

### DETAILED DESCRIPTION

A method of making a cook utensil and a cooking utensil made from the same are disclosed herein.

The term ‘overlying’ as used herein means ‘above, but not necessarily contacting’. For example, a first polymer film overlying a metal substrate means the first polymer film is above the metal substrate, but there may be or may not be an intervening layer between the first polymer film and the metal substrate.

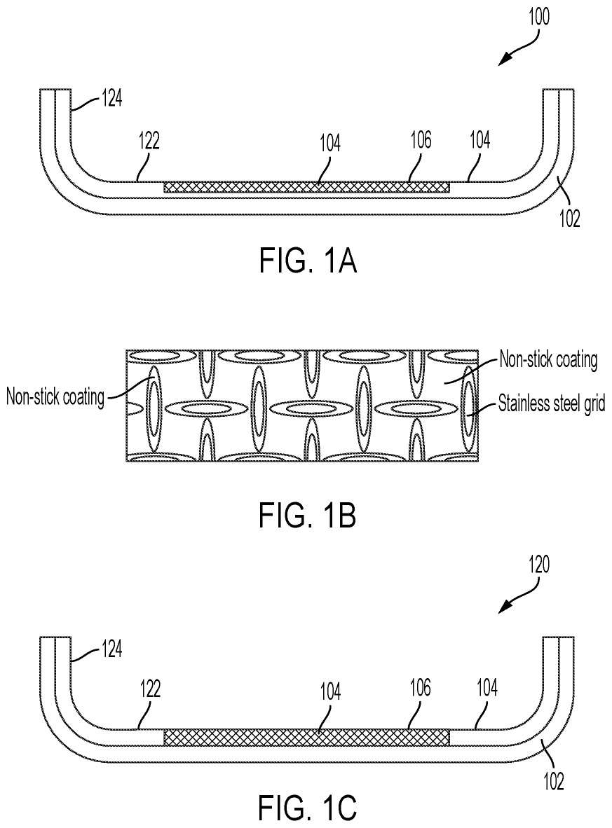

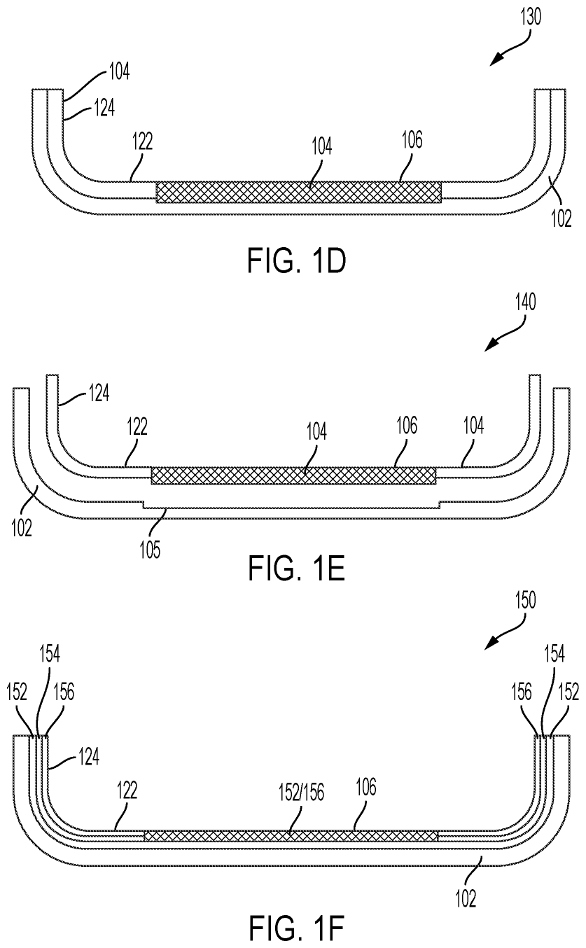

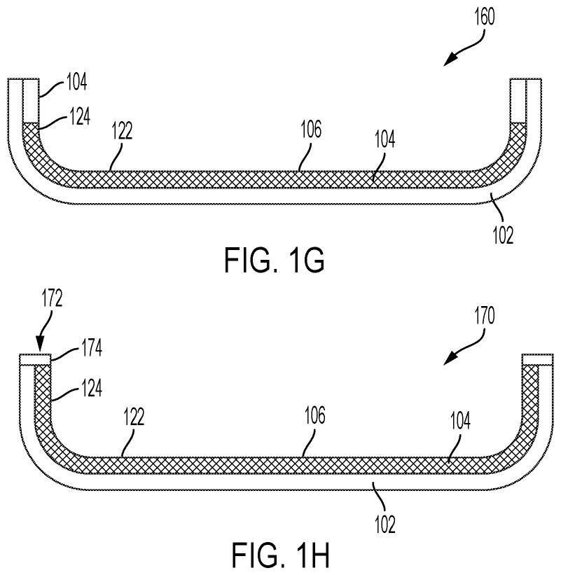

FIG. 1A a schematic cross-sectional view of a cooking utensil 100 in accordance with some embodiments of the present disclosure.

The cooking utensil 100 includes a metal substrate 102, a polymer film 104 overlying the metal substrate, and mesh layer 106 embedded in the polymer film 104. By ‘embedded’ it is meant that the polymer film 104 is disposed in and through void spaces of the mesh layer 106 and covers a substantial portion of the mesh layer 106. However, the mesh layer 106 is exposed at a cooking surface 122 of the utensil 100. The exposure of the mesh layer 106 is about 25% or less of the area of the cooking surface 122 that includes the mesh layer 106. In some embodiments, the exposure of the mesh layer 106 is about 20% or less of the area of the cooking surface 122 that includes the mesh layer 106. In some embodiments, the exposure of the mesh layer 106 is about 5% to about 15% of the area of the cooking surface 122. An exemplary image of mesh layer exposure at a cooking surface is depicted in FIG. 1B.

As depicted in FIG. 1A, the cooking surface 122 is the horizontal surface of the cooking utensil 100. The cooking utensil 100 is an exemplary embodiment. A cooking utensil of the present disclosure can be a pot, a pan, a vat, an appliance or the like. The cooking utensil 100 further includes sidewalls 124 that surround the cooking surface 122 and extend above the cooking surface 122. As discussed in embodiments of the cooking utensil in FIGS. 1G and 1H, the mesh layer 106 can extend along the sidewalls 124 and may extend along the entire sidewall 124. In such embodiments, the exposure of the mesh layer 106 may be about 25% or less per unit area of the region of the surface that includes the mesh layer. In some embodiments, the exposed mesh layer 106 may be about 20% or less per unit area, or about 5% to about 15% per unit area. In FIG. 1A, the ‘region of the surface that includes the mesh layer’ is the portion of the cooking surface 122 extending to the periphery of the mesh layer 106.

As depicted in FIG. 1A, the mesh layer 106 is separated from the metal substrate 102 and does not contact the metal substrate 102. This is merely one exemplary embodiment. As discussed herein, there are embodiments of a cooking utensil where the mesh layer can contact and/or be partially embedded in the metal substrate.

The metal substrate 102 may be any suitable metal substrate used in a cooking utensil. The metal substrate may be single layer or multilayer. Exemplary metal substrates include solid aluminum, solid stainless steel, solid titanium, carbon steel, a multilayer substrate having a copper core and a stainless steel surface, and a multilayer substrate having an aluminum core and a stainless steel surface, a multilayer substrate having an aluminum core and a titanium surface, a multilayer substrate having a copper core and a titanium surface, a multilayer substrate having an aluminum core and a carbon steel surface, a multilayer substrate having a copper core and a carbon steel surface. In some embodiments, the metal substrate may be a multilayer structure including a graphite core, such as described in U.S. Pat. Nos. 10,081,163; 10,717,252; and 11,364,706, and U.S. Patent Publication No. 2021/0177195, which are incorporated by reference herein. Metal substrate may be pretreated to create texture on the surface for improved bonding to the polymer film. Exemplary pretreatment processes can include chemical etching, grit blasting, belt sanding, arc spraying, and the like. In some embodiments, the mesh layer 106 may embed in certain metal substrates and not in others. For example, the mesh layer 106 may embed in the surface of a soft metal, such as aluminum, and may not embed in the surface of a hard metal, such as stainless steel.

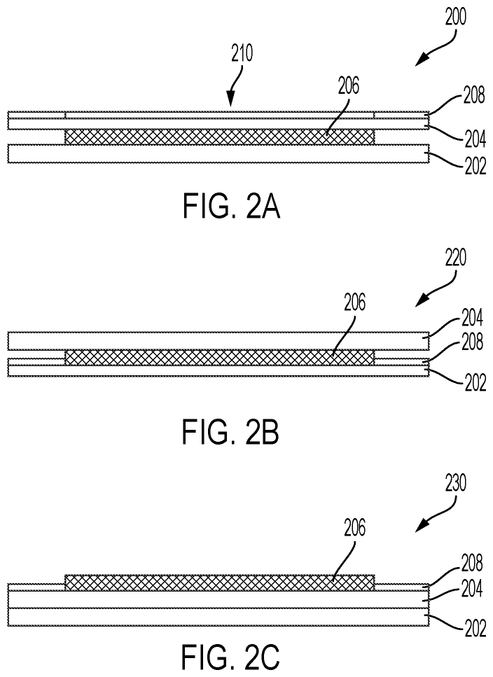

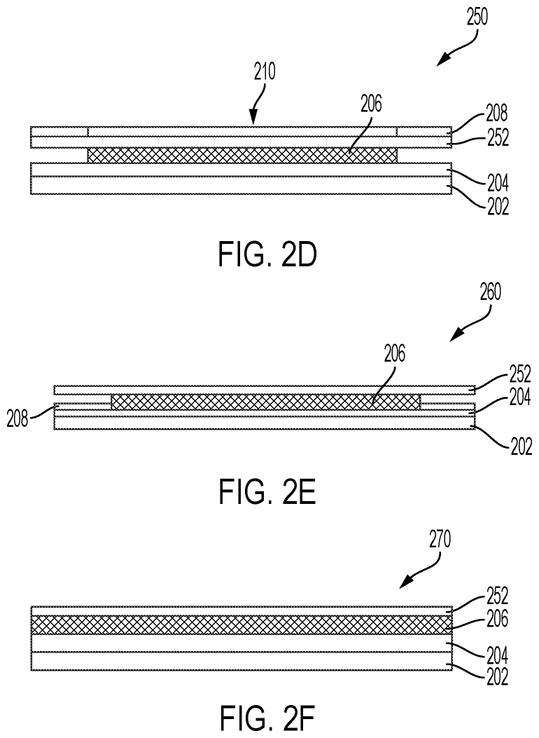

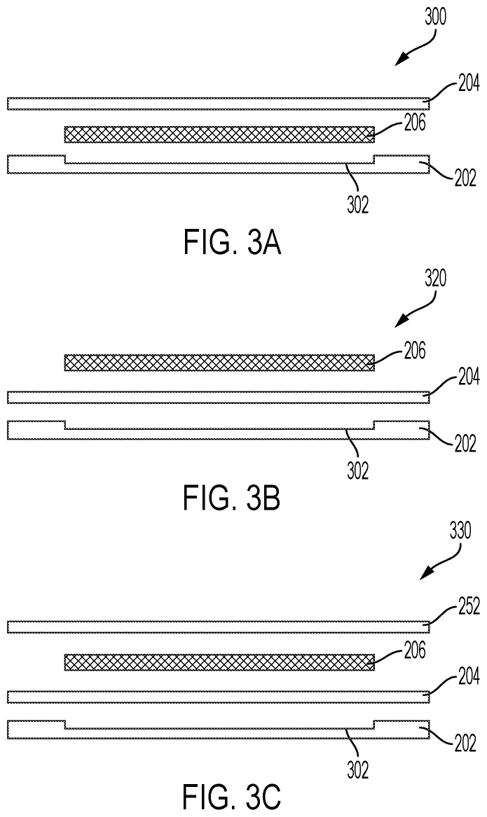

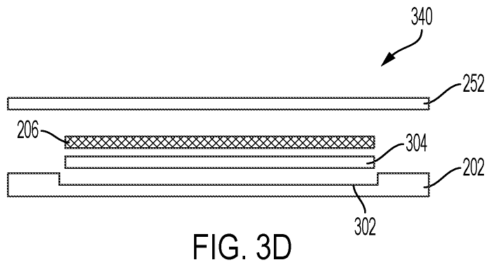

The polymer film 104 may be any suitable polymer film that can be used to create a non-stick surface. The polymer film may be single layer or multilayer. The polymer film is pre-fabricated prior to including the polymer film in a multilayer stack (discussed below in accordance with FIGS. 2A to 2F and FIGS. 3A to 3D). In some embodiments, the polymer film may be prepared by a casting method, a cutting method, wherein the cutting method can include skiving, an extrusion method, and a calandering method. The polymer film is not fabricated in situ, for example, by a spray method. Advantages of a pre-fabricated polymer film is a more dense polymer film having uniform thickness. A spray method requires evaporation of a solvent used to spray on the polymer. During the evaporation process, voids in the spray on polymer film may be left behind. These voids can trap oil, grease, food particles, and other cooking liquids, which can result in degradation of the spray on polymer film. The thickness of the polymer film 104 can range from about 0.001 inches to about 0.02 inches.

The polymer film 104 comprises one or more of selected from the group consisting of polytetrafluoroethylene (PTFE), tetrafluoroethylene-hexafluoropropylene copolymer (FEP), tetrafluorocthylene-perfluoroalkyl vinyl ether (PFA), ethylene-tetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE) and ethylene-chlorotrifluoroethylene copolymer (ECTEF), polyether ether ketone (PEEK), polyaryletherketone (PAEK), or combinations thereof. In some embodiments, the polymer film is PTFE.

The mesh layer 106 may be any suitable mesh pattern used in a cooking utensil. Exemplary mesh patterns include woven mesh, expanded mesh, or the like. In some embodiments, the mesh layer is a woven mesh pattern. For example, when the mesh layer is a woven mesh pattern, the polymer present at the cooking surface is an interconnected and continuous polymer film, such as illustrated in FIG. 1B, where polymer present between exposed parts of the mesh layer are interconnected to polymer present between other exposed parts of the mesh layer. In contrast, if an expanded mesh is used, due to the nature of the expanded mesh, the polymer present at the cooking surface between one part of the exposed mesh is not interconnected with the polymer present between another part of the exposed mesh.

The mesh can be made of stainless steel, titanium, or any other suitable metallic material. The mesh layer has a thickness ranging from about 0.004 inches to about 0.025 inches. The mesh pattern can be woven, having a density of about 10 wires per inch to 200 wires per inch. The gauge of the wire for the woven mesh can range from about 0.002 inch to about 0.0125 inch. When embedded in the polymer film, the surface area of the mesh exposed at the surface of the polymer film is about 25% or less, about 20% or less, about 5% to about 15%, based on the total surface area of the region of the polymer film that includes the mesh. In some embodiments, the percentage of the mesh layer 106 exposed on the surface and/or sidewall of the cooking utensil can be a result of where the mesh layer is arranged in a multilayer stack prior to lamination by pressure bonding. For example, if the mesh layer 106 is arranged closer to the top of the multilayer stack, where the top being the part of the stack that will eventually form the cooking surface, more of the mesh layer 106 may be exposed after lamination.

FIG. 1C depicts a schematic cross-sectional view of a cooking utensil 120 in accordance with some embodiments of the present disclosure. Other than where specifically mentioned, the utensil 120 is the same as the utensil 100. In the utensil 120, the mesh layer 106 may contact the metal substrate 102. For example, when the metal substrate 102 is a hard material, such as stainless steel, the mesh layer 106 may not embed in the metal substrate 102. For example, when the thickness of a polymer film in a multilayer stack used to form the cooking utensil is at a minimum critical thickness (T_{F}) as discussed below, the mesh layer 106 may contact the metal substrate 102.

FIG. 1D depicts a schematic cross-sectional view of a cooking utensil 130 in accordance with some embodiments of the present disclosure. Other than where specifically mentioned, the utensil 130 is the same as the utensil 100. In the utensil 130, the mesh layer 106 may be partially embedded in the metal substrate 102. For example, when the metal substrate 102 is made of a soft material, such as aluminum, the mesh layer 106 may be partially embedded in the metal substrate 102. However, embedding of the mesh layer is controlled by various aspects of the pressure bonding process, such as time, temperature, thickness of the polymer film, and the like. A mesh layer partially embedded in the metal substrate when a soft material is used for the metal substrate is an exemplary embodiment. In some embodiments, a soft material can be used for the metal substrate and the mesh layer may contact the metal substrate but not be embedded or not contact the metal substrate, i.e., a polymer film may separate the mesh layer from the metal substrate.

FIG. 1E depicts a schematic cross-sectional and exploded view of a cooking utensil 140 in accordance with some embodiments of the present disclosure. Other than where specifically mentioned, the utensil 140 is the same as the utensil 100. In the utensil 140, the mesh layer 106 may rest in a notch 105, where the notch 105 is present in the metal substrate 102. The notch 105 may have similar dimensions, e.g., diameter, length, and/or width, as the mesh layer 106. For the mesh layer 106 to be exposed on the cooking surface 122, the mesh layer 106 has a thickness that is greater than the depth of the notch 105 such that the mesh layer 106 extends above the notch 105. The notch 105 can be utilized during a method of making the cooking utensil to achieve a cooking utensil having a smooth cooking surface in the areas of the cooking surface that does not include the mesh layer.

FIG. 1F depicts a schematic cross-sectional view of a cooking utensil 150 in accordance with some embodiments of the present disclosure. Other than where specifically mentioned, the utensil 150 is the same as the utensil 100. The utensil 150 includes the metal substrate 102. Disposed on the metal substrate is a first polymer film 152, overlying the first polymer film 152 is an additional layer 154 having an opening. The additional layer 154 can be a metal, a non-polymer material, or a polymer material that is preferably different from the polymer material in at least one of film 156 or film 152. For example, the polymer materials in each film 152 to 156 could be the same, but distinguishable based on molecular weight, isotropy, or the like. The opening of the additional layer 154 surrounds the mesh layer 106 at the peripheral edge thereof. A second polymer film 156 overlies the additional layer 154. The first and second polymer films 152, 156 may contact through the mesh layer 106. Depending on lamination conditions the first polymer film 152 may separate the mesh layer 106 and the metal substrate 102 as shown in FIG. 1F. However, other embodiments are possible, such as the mesh layer 106 contacting the metal substrate 102 or being partially embedded in the metal substrate 102. The utensil 150 may be constructed using a stack 260 (depicted in FIG. 2E) provided that the additional layer having the opening is a metal, non-polymer material, or a polymer material distinguishable from at least one of the films 152, 156.

FIG. 1G depicts a schematic cross-sectional view of a cooking utensil 160 in accordance with some embodiments of the present disclosure. The utensil 160 is the same as the utensil 120, except the mesh layer 106 is not limited to being disposed on the cooking surface 122 and can extend along the sidewall surfaces 124 of the cooking utensil 160 as shown in FIG. 1G. FIG. 1G depicts the mesh layer 106 in accordance with the embodiment depicted in FIG. 1C, where the mesh layer 106 contacts the metal substrate 102. FIG. 1G is merely an exemplary embodiment. The mesh layer as depicted in FIG. 1A, 1D or 1E, where the mesh layer is separated from the metal substrate, embedded in the metal substrate, or rests in a notch, could also extend up the sidewalls of the cooking utensil.

FIG. 1H depicts a schematic cross-sectional view of a cooking utensil 170 in accordance with some embodiments of the present disclosure. The cooking utensil 170 is similar to that of the cooking utensil 150, except the mesh layer 106 extends along the entire sidewall 124 of the cooking utensil 170 and to a peripheral edge 172 of the cooking utensil 160. At the peripheral edge 172, the mesh layer 106 can protrude causing a rough edge which can, for example, injure the user of the cooking utensil. A cap 174 can be present at the peripheral edge 172 to cover the exposed mesh layer 106 and create a smooth surface. FIG. 1H is merely an exemplary embodiment. The mesh layer as depicted in FIG. 1A or ID, where the mesh layer does not contact the metal substrate or is embedded in the metal substrate, could also extend up the sidewalls of the cooking utensil.

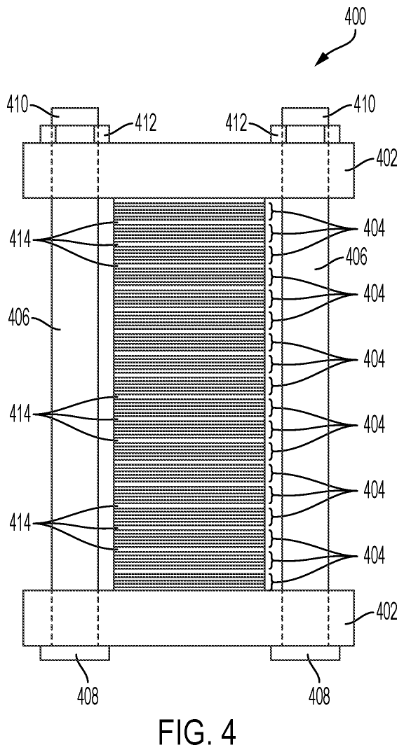

A method of making the cooking utensil of the present disclosure includes laminating a multilayer stack and shaping the laminated multilayer stack into a cooking utensil. The lamination process (a pressure bonding process) includes applying pressure and temperature to the multilayer stack to laminate the components of the stack. A pressure fixture or jig 400, disclosed below in reference to FIG. 4, can be used to apply the pressure required. Once the pressure is applied, temperature can be applied to laminate the stack by conventional means, such as a furnace, oven, induction, or the like. The heating may be performed in an inert atmosphere, such as nitrogen or the like, or in a vacuum. The heating may range from about 250 degrees Celsius to about 500 degrees Celsius.

The pressure is applied in a direction normal to the thickness of the multilayer stack. The pressure can range from about 300 bar to about 1,000 bar. Once the pressure is applied, the temperature used to laminate the multilayer stack may range from about 250 degrees Celsius to about 500 degrees Celsius. Once the pressure has been applied, combination of pressure and temperature may be applied for a total time of about 10 minutes to about 180 minutes.

Once the multilayer stack is laminated, it may be shaped or molded into a cooking utensil by any methods know in the art, such as spinning, hydroforming, hydraulic press, double action press forming, toggle press forming, or the like.

Optionally, after lamination of the multilayer stack or after shaping of the laminated stack into a cooking utensil, the stack may be cryogenically treated. In some embodiments, the temperature of the cryogenic treatment may be −73.3 degrees Celsius or less. The cryogenic treatment may improve the properties of the polymer film, the metal substrate, or both. The cryogenic treatment is described in U.S. Pat. No. 6,544,669, the entire contents of which is incorporated by reference herein.

Several embodiments of a multilayer stack can be utilized to achieve the cooking utensils disclosed in FIGS. 1A, and 1C to 1H.

FIG. 2A depicts a schematic cross-sectional view of a multilayer stack 200 prior to lamination in accordance with some embodiments of the present disclosure. The stack may be in any suitable shape (when viewed in the direction of thickness of the stack) that is convenient for molding or shaping the stack into a cooking utensil. Suitable shapes may include circular, square, rectangular, or the like. The multilayer stack includes a metal substrate 202, a mesh layer 206 overlying the metal substrate 202, and a polymer film 204 overlying the mesh layer 206. The metal substrate 202, polymer film 204, and mesh layer 206 may have the same composition and characteristics as described above for the metal layer 102, the polymer film 104, and mesh layer 106, respectively. The mesh layer 206 is depicted in FIG. 2A as having a smaller diameter (when a circular shape is used) than the metal substrate 202 and polymer film 204. This depiction of the mesh layer 206 is merely exemplary and the mesh layer 206 can have a surface area in the horizontal plane (the horizontal plane being perpendicular to a thickness of the stack) up to the same size as the metal substrate 202 and polymer film 204. For example, the size of the mesh layer 206 may be varied depending upon the desired cooking utensil. For example, when the stack is circular, a mesh layer 206 having a smaller diameter than the substrate 202 and film 204 can be used when the mesh layer is meant to be only on the cooking surface, such as depicted in FIG. 1A, where the mesh layer occupies the cooking surface 122 and not the sidewalls 124. A mesh layer 206 having a diameter closer to or equal to the substrate 202 and film 204 can be used when the mesh layer is meant to extend along the sidewalls of the utensil such as in FIG. 1G or 1H. Further, the shape of the mesh layer, metal substrate and polymer film need not be circular. Any suitable shape that allows the stack to be shaped into the desired cooking utensil can be used. In an embodiment of a non-circular shaped mesh layer, metal substrate and polymer film for FIG. 2A, when viewed in the direction of thickness of the multilayer stack, the peripheral edges of the metal substrate and the polymer film would extend beyond the peripheral edges of the mesh layer when arranged in the multilayer stack.

The stack 200 includes an additional layer 208 overlying the polymer film 204, where the additional layer 208 has an opening 210 overlying a region of the polymer film 204 that overlies the mesh layer 206. The additional layer 208 may be, for example, in the shape of a ‘donut’ where the ‘hole’ at the center of the ‘donut’ is aligned with the mesh layer 206 in the direction of thickness of the stack. The dimensions of the opening 210 may exceed the dimensions of the mesh layer 206 such that the opening 210 could surround the mesh layer 206 if the additional layer 208 and the mesh layer 206 were arranged in the same plane. The dimensions of the opening 210 should be substantially similar to that of the mesh layer to prevent shifting and/or misalignment of the mesh and the additional layer. The dimensions of the opening in the additional layer 208 may exceed that of the mesh layer by up to about 0.008 inches. For example, when the opening and the mesh layer are both circular, the diameter of the opening may exceed that of the mesh layer by up to about 0.016 inches. The additional layer 208 can be one of an inert layer, i.e., a layer that is used during the lamination process which can withstand the pressure and temperature and does not laminate to the stack and can be removed from the stack after lamination is complete, a polymer film that becomes a permanent component of the laminated stack, or a metal or non-polymer material that becomes a permanent component of laminated stack. The inert layer can be one of a ceramic, stainless steel, a polyimide, such as KAPTON®, or another material that does not laminate upon pressure and heating with the stack. When the additional layer 208 is a polymer film, the polymer film may be any suitable polymer discussed herein with regards to the polymer film 104.

When sufficient pressure and temperature are applied, the mesh may be driven into the polymer film and may be driven as far as being embedded in the metal substrate. Prior to lamination, the metal substrate 202 (or a layer of the metal substrate when the metal substrate is a multilayer structure) may range in thickness from about 0.04 inches to about 0.2 inches. Prior to lamination, the mesh layer 206 may have a thickness from about 0.004 inches to about 0.025 inches. Prior to lamination, the polymer film 204 may have a thickness from about 0.001 inches to about 0.02 inches. Further, the thicknesses of the polymer film 204 and the layer 208 must be selected such that upon lamination, the mesh will be exposed at the surface. For example, if the total thickness of the polymer film(s) 204 and additional layer 208 exceed that of the mesh layer 206, upon lamination the mesh will not be exposed on the surface. Similarly, the total thickness of the polymer film 204 and additional layer 208 can be selected relative to the thickness of the mesh layer to tailor the amount of mesh layer exposed on the surface.

Upon application of pressure and temperature, the additional layer 208 reduces the volume of space into which the polymer film 204 can expand into. The polymer film 204 having a higher coefficient of thermal expansion than the mesh layer 206, will have an uneven and roughened surface in the portions of the polymer film 204 not overlying the mesh layer 206, unless the layer 208 is used to resist the expansion of the polymer film 204 during heating and compression. By using the additional layer 208, the surface of the portions of the polymer film 204, which do not include the mesh layer 206 embedded therein, will be smooth. The formation of a laminated multilayer stack with and without using the layer 208 is described in the Example and Comparative Example below.

FIG. 2B depicts a schematic cross-sectional view of a multilayer stack 220 prior to lamination in accordance with some embodiments of the present disclosure. The multilayer 220 is a variation of the multilayer stack 200. Unless otherwise mentioned, the multilayer stack 220 is the same as the stack 200. In the multilayer stacked 220, the additional layer 208 is disposed between the metal substrate 102 and the polymer film 204. The additional layer 208 surrounds the mesh layer 206 which is also disposed between the metal substrate 202 and the polymer film 204. Because of the position of the additional layer 208 between the polymer film 204 and the metal substrate 202, the additional layer 208 cannot be an inert layer used during the bonding process that can later be removed. In this embodiment, the additional layer 208 is a polymer, a metal, or a non-metal that will become a permanent part of the cooking utensil after lamination. The stack 200 and the stack 220 can be utilized to make a cooking utensil such as utensil 120 in FIGS. 1C and 1D, where the mesh layer contacts the metal substrate or is partially embedded in the metal substrate. The stack 220 can further be utilized to make the cooking utensil 150 as shown in FIG. 1F provided the additional layer is a metal, non-polymer material, or a polymer material distinguishable from film 204, and provided layer 152 was absent.

FIG. 2C depicts a schematic cross-sectional view of a multilayer stack 230 prior to lamination in accordance with some embodiments of the present disclosure. The multilayer stack 230 is similar to the multilayer stack 220, except in the multilayer stack 230 the polymer film 204 is disposed between the metal substrate and both the mesh layer 206 and the additional layer 208. Because the additional layer 208 is an outer layer in the stack 230, the additional layer 208 could be a polymer film or an inert layer that can be removed after lamination. The stack 230 may be used to prepare a cooking utensil such as utensil 100 where the mesh layer 106 is separated from the metal substrate by the polymer film 104.

FIG. 2D depicts a schematic cross-sectional view of a multilayer stack 250 prior to lamination in accordance with some embodiments of the present disclosure. The multilayer stack 250 includes the metal substrate 202, the polymer film 204 overlying the metal substrate 202, the mesh layer 206 overlying the polymer film 204, a second polymer film 252 overlying the mesh layer 206. The mesh layer 206 is smaller than the metal substrate 202 and polymer films 204, 252. The second polymer film 252 may be the same as, or different from the polymer film 204 in terms of composition and/or thickness. The stack 250 includes the additional layer 208 overlying the second polymer film 252, where the additional layer 208 has the opening 210 overlying a region of the second polymer film 252 that overlies the mesh layer 206. The additional layer 208, being the outermost layer in the stack 250 can be either a polymer film or an inert layer.

FIG. 2E depicts a schematic cross-sectional view of a multilayer stack 260 prior to lamination in accordance with some embodiments of the present disclosure. The stack 260 is similar to the stack 250 except the additional layer 208 and the mesh layer 206 are disposed between the polymer films 204, 252. In this embodiment, the additional layer 208 can be a polymer, a metal, or a non-polymer material and becomes a permanent part of the stack when laminated. The stacks 250 and 260 could be utilized to make utensils 100, 130, and 140. The stack 260 could be further utilized to make utensil 150.

FIG. 2F depicts a schematic cross-sectional view of a multilayer stack 270 prior to lamination in accordance with some embodiments of the present disclosure. The stacks depicted in FIGS. 2A to 2E have a common feature in that the dimensions of the mesh layer are smaller than those of the polymer film and metal substrate. In those stacks the smaller mesh layer 206 results in a volume difference in the region adjacent to the mesh layer and that volume difference is addressed by the presence of the additional layer with the opening. In contrast, in the stack 270, the polymer film 204, the mesh layer 206 and the polymer film 252 each has the same dimensions. Accordingly, in the stack 270, there is no volume difference that needs to be addressed by the layer with the opening.

Moreover, the inventors have further contemplated the stacks 200 to 260 where the dimensions of the mesh layer is smaller than that of the polymer film(s) and the metal substrate. It is possible that the additional layer with the opening would not be needed and a laminated stack having a smooth surface in the region that does not overlie the mesh layer could be achieved. However, the mesh layer used for such a stack would have to have a thickness that was so small that the volume difference caused by the presence of the mesh was negligible. Mesh is used as reinforcement on the cooking surface and having the mesh completely embedded into the polymer film (not exposed) would then provide no reinforcement on the cooking surface and would defeat the purpose of adding the mesh.

Further, the inventors have contemplated alternatives for the additional layer having the opening in the stacks 200 to 260. It may be possible to achieve the same results by excluding the additional layer with the opening, and instead notching the metal substrate. A notch in the metal substrate would have similar dimensions as the mesh layer. However, the mesh layer would have a thickness greater than the depth of the notch such that the mesh layer could be exposed on the cooking surface after pressure bonding. Thus, the notch in the metal substrate would serve the same purpose as the additional layer having the opening. Embodiments of unlaminated multilayer stacks using a notch instead of the additional layer having the opening are depicted in FIGS. 3A to 3B.

FIG. 3A depicts a schematic cross-sectional view of a multilayer stack 300 prior to lamination in accordance with some embodiments of the present disclosure. The multilayer stack 300 is depicted in an exploded cross-sectional view for ease of viewing the notch in the metal substrate. In the multilayer stacked 300, the metal substrate 202 includes a notch 302 having similar dimensions to the mesh layer 206 such that the mesh layer can rest in the notch 302. The dimensions of the notch 302 may exceed the dimensions of the mesh layer 206 by up to about 0.008 inch. For example, if the mesh layer 206 is in a circular shape, the diameter of the notch 302 may exceed the diameter of mesh layer 206 by up to about 0.016 inches. The mesh layer 206 is disposed between the metal substrate 202 and the polymer film 204.

FIG. 3B depicts a schematic cross-sectional view of a multilayer stack 320 prior to lamination in accordance with some embodiments of the present disclosure. The multilayer stack 320 is depicted in an exploded cross-sectional view for ease of viewing the notch in the metal substrate. In the multilayer stacked 320, the metal substrate 202 includes the notch 302 having similar dimensions to the mesh layer 206 such that the mesh layer can rest in the notch 302. The relationship between the dimensions of the notch and the mesh layer are the same as those described above in FIG. 3A. The polymer film 204 is disposed between the metal substrate 202 and the mesh layer 206.

FIG. 3C depicts a schematic cross-sectional view of a multilayer stack 330 prior to lamination in accordance with some embodiments of the present disclosure. The multilayer stack 330 is depicted in an exploded cross-sectional view for ease of viewing the notch in the metal substrate. In the multilayer stack 330, the metal substrate 202 includes the notch 302 having similar dimensions to the mesh layer 206 such that the mesh layer can rest in the notch 302. The relationship between the dimensions of the notch and the mesh layer are the same as those described above in FIG. 3A. In the multilayer stack 330, the polymer film 252, the mesh layer 206, the polymer film 204 and the metal substrate 202 including the notch 302 are sequentially arranged. The stacks 300, 320, and 330 can be utilized to make a cooking utensil such as utensil 140 in FIG. 1E, where the mesh layer rests in the notch.

FIG. 3D depicts a schematic cross-sectional view of a multilayer stack 340 prior to lamination in accordance with some embodiments of the present disclosure. The multilayer stack 340 is depicted in an exploded cross-sectional view for ease of viewing the notch in the metal substrate. In the multilayer stacked 340, the metal substrate 202 includes the notch 302 having similar dimensions to the mesh layer 206 such that the mesh layer can rest in the notch 302. The relationship between the dimensions of the notch and the mesh layer are the same as those described above in FIG. 3A. In the multilayer stack 340, the polymer film 252, the mesh layer 206, a polymer film 304 and the metal substrate 202 including the notch 302 are sequentially arranged. In multilayer stack 340, the polymer film 304 has similar and/or the same dimensions as the mesh layer 206 in the x-y plane, the thickness of the stack 340 being the z-direction. The stacks 300, 320, 330 and 340 can be utilized to make a cooking utensil such as utensil 140 in FIG. 1E, where the mesh layer is disposed in the notch.

In the above-referenced embodiments, the mesh layer is partially exposed through the polymer film on the cooking surface and/or side walls. Further, the mesh layer can contact the surface of the metal substrate, not contact the surface of the metal substrate, or be embedded in the surface of the metal substrate. For example, if the polymer film thickness is excessive, then the mesh layer may not be exposed upon lamination. Accordingly, a series of equations can be used to determine the thickness of the polymer film(s), additional layer having the opening, and/or the thickness of the notch to ensure that the mesh layer is exposed on the cooking surface, and further that the surfaces not containing the mesh layer are smooth surfaces. The following equations (1) to (3) apply to all embodiments:

$${W}_{2} = A \times {T}_{M} \times {d}_{M} \qquad ( 1 )$$

$$V = 1 - ( {W}_{1} / {W}_{2} ) \qquad ( 2 )$$

$${T}_{F} = V \times {T}_{M} \qquad ( 3 )$$

In Equations (1) to (3), A is surface area of the mesh layer in a horizontal plane that is perpendicular to the thickness direction of stack, Tₘ is thickness of the mesh layer (e.g., about 2 times wire diameter for a woven mesh), d_{M} is density of the material used in the mesh layer (e.g., a density of steel, a density of aluminum, a density of the wire of the mesh relative to the volume of the wire), W₁ is weight of a mesh layer having area A and thickness Tₘ, W₂ is weight of a solid layer of the mesh material having area A and thickness Tₘ, V is a ratio of a volume of void space within the volume of the mesh layer having surface area A and thickness Tₘ presuming W₁ and W₂ are made of the same material, and T_{F} is a thickness of polymer film need to fill the volume of the void space within the mesh layer having surface area A and thickness Tₘ. In one exemplary embodiment, V=0.75, Tₘ=0.015 inch, and T_{F}=0.01125 inch. Generally, T_{F} can be considered a lower limit. For example, in the embodiment of FIG. 2C, if a thickness of the polymer film 204 is less than T_{F} then the mesh layer 206 will bond to the metal substrate 202. However, the cooking surface of the resulting cooking utensil will have more exposed metal from the mesh layer and inferior non-stick properties. For example, in the embodiments of FIGS. 2A-2B, if a thickness of the polymer film 204 is less than T_{F} then the mesh layer 206 will not bond to the metal substrate 202.

In the embodiments of FIG. 2F, to obtain a laminate whereby the mesh layer contacts the metal substrate, and the mesh layer is exposed on the cooking surface, the top polymer film and the bottom polymer film should have a total thickness of T_{F}, i.e., T_{F}=T_{T}+T_{B}, where T_{T} is the thickness of the top polymer film and T_{B} is the thickness of the bottom polymer film. A thickness ratio of T_{T} to T_{B} can be any suitable amount, such as 1:1, 4:6, 3:7, and the like, provided T_{F}=T_{T}+T_{B}.

In the embodiments of FIG. 2F, to obtain a laminate whereby the mesh layer does not contact the metal substrate and the mesh layer is exposed on the cooking surface, the top polymer film and the bottom polymer film should have a total thickness of C×T_{F}, where C>1. For example, C may equal 1.1, 1.2, 1.3, 1.4, 1.5, or the like. However, if C becomes too large, then it will be difficult to obtain a cooking surface where the mesh layer is exposed through the polymer film. In this embodiment, wherein the mesh layer does not contact the metal substrate, T_{FNo}=C×T_{F}=T_{T}+T_{B}, where T_{FNo} is the thickness needed for no contact between the mesh layer and the metal substrate, T_{T} is the thickness of the top polymer film and T_{B} is the thickness of the bottom polymer film. A thickness ratio of T_{T} to T_{B} can be any suitable amount, such as 1:1, 4:6, 3:7, and the like, provided T_{FNo}=T_{T}+T_{B} and T_{B}≥T_{T}. If T_{T} is greater than T_{B} than the mesh layer may not be exposed through the polymer film on the top surface.

In the embodiments of FIGS. 2A-2C, to obtain a laminate whereby the mesh layer contacts the metal substrate and the mesh layer is exposed on the cooking surface, T_{D}=T_{M}−T_{F}, where T_{D} is the thickness of the additional layer having the opening.

In the embodiment of FIG. 2C, to obtain a laminate whereby the mesh layer does not contact the metal substrate and the mesh layer is exposed on the cooking surface, T_{D}=T_{M}−T_{FNo}, where T_{D} is the thickness of the additional layer having the opening, and T_{FNo}=C×T_{F} as defined above. If T_{FNo} is used for the embodiments of FIGS. 2A-2B it is possible that if C is sufficiently small then the mesh layer can be bonded to the metal substrate and also exposed on the top surface. However, if C is too large for T_{FNo} in the embodiments of FIGS. 2A-2B then the mesh layer may bond to the metal substrate but not be exposed on the top surface.

In the embodiments of FIGS. 2D-2E, to obtain a laminate whereby the mesh layer contacts the metal substrate, and the mesh layer is exposed on the cooking surface, T_{D}=T_{M}−T_{F}, where T_{D} is the thickness of the additional layer having the opening and T_{F}=T_{T}+T_{B}, where T_{T} is the thickness of the top polymer film and T_{B} is the thickness of the bottom polymer film. A thickness ratio of T_{T} to T_{B} can be any suitable amount, such as 1:1, 4:6, 3:7, and the like, provided T_{F}=T_{T}+T_{B}.

In the embodiments of FIGS. 2D-2E, to obtain a laminate whereby the mesh layer does not contact the metal substrate and the mesh layer is exposed on the cooking surface, T_{D}=T_{M}−T_{FNo}, where T_{D} is the thickness of the additional layer having the opening and T_{FNo}=C×T_{F}=T_{T}+T_{B}, where T_{T} is the thickness of the top polymer film and T_{B} is the thickness of the bottom polymer, where T_{FNo} is the thickness needed for no contact between the mesh layer and the metal substrate, and where C>1. For example, C may equal 1.1, 1.2, 1.3, 1.4, 1.5, or the like. However, if C becomes too large, then it will be difficult to obtain a cooking surface where the mesh layer is exposed through the polymer film. A thickness ratio of T_{T} to T_{B} can be any suitable amount, such as 1:1, 4:6, 3:7, and the like, provided T_{FNo}=T_{T}+T_{B} and T_{B}≥T_{T}.

In the embodiments of FIGS. 3A-3B, to obtain a laminate whereby the mesh layer contacts the metal substrate at the bottom of the notch and the mesh layer is exposed on the cooking surface, T_{N}=T_{M}−T_{F}, where T_{N} is the thickness of the notch.

In the embodiment of FIG. 3B, to obtain a laminate whereby the mesh layer does not contact the metal substrate at the bottom of the notch and the mesh layer is exposed on the cooking surface, T_{N}=T_{M}−T_{FNo}, where T_{N} is the thickness of the notch, and T_{FNo}=C×T_{F} as defined above. If T_{FNo} is used for the embodiments of FIG. 3A, it is possible that if C is sufficiently small then the mesh layer can be bonded to the metal substrate and also exposed on the top surface. However, if C is too large for T_{FNo} in the embodiment of FIG. 3A, then the mesh layer may bond to the metal substrate but not exposed on the top surface.

In the embodiments of FIG. 3C, to obtain a laminate whereby the mesh layer contacts the metal substrate at the bottom of the notch and the mesh layer is exposed on the cooking surface, T_{N}=T_{M}−T_{F}, where T_{N} is the thickness of the notch and T_{F}=T_{T}+T_{B}, where T_{T} is the thickness of the top polymer film and T_{B} is the thickness of the bottom polymer film. A thickness ratio of T_{T} to T_{B} can be any suitable amount, such as 1:1, 4:6, 3:7, and the like, provided T_{F}=T_{T}+T_{B}.

In the embodiments of FIG. 3C, to obtain a laminate whereby the mesh layer does not contact the metal substrate and the mesh layer is exposed on the cooking surface, T_{N}=T_{M}−T_{FNo}, where T_{N} is the thickness of the notch and T_{FNo}=C×T_{F}=T_{T}+T_{B}, where T_{T} is the thickness of the top polymer film and T_{B} is the thickness of the bottom polymer, where T_{FNo} is the thickness needed for no contact between the mesh layer and the metal substrate, and where C>1. For example, C may equal 1.1, 1.2, 1.3, 1.4, 1.5, or the like. However, if C becomes too large, then it will be difficult to obtain a cooking surface where the mesh layer is exposed through the polymer film. A thickness ratio of T_{T} to T_{B} can be any suitable amount, such as 1:1, 4:6, 3:7, and the like, provided T_{FNo}=T_{T}+T_{B} and T_{B}≥T_{T}.

In the embodiments of FIG. 3D, to obtain a laminate whereby the mesh layer contacts the metal substrate at the bottom of the notch and the mesh layer is exposed on the cooking surface, T_{N}=T_{M}−T_{F}+T_{B}, where T_{N} is the thickness of the notch and T_{F}=T_{T}+T_{B}, where T_{T} is the thickness of the top polymer film and T_{B} is the thickness of the bottom polymer film. A thickness ratio of T_{T} to T_{B} can be any suitable amount, such as 1:1, 4:6, 3:7, and the like, provided T_{F}=T_{T}+T_{B}.

In the embodiments of FIG. 3D, to obtain a laminate whereby the mesh layer does not contact the metal substrate and the mesh layer is exposed on the cooking surface, T_{N}=T_{M}−T_{FNo}+T_{B}, where T_{N} is the thickness of the notch and T_{FNo}=C×T_{F}=T_{T}+T_{B}, where T_{T} is the thickness of the top polymer film and T_{B} is the thickness of the bottom polymer, where T_{FNo} is the thickness needed for no contact between the mesh layer and the metal substrate, and where C>1. For example, C may equal 1.1, 1.2, 1.3, 1.4, 1.5, or the like. However, if C becomes too large, then it will be difficult to obtain a cooking surface where the mesh layer is exposed through the polymer film. A thickness ratio of T_{T} to T_{B} can be any suitable amount, such as 1:1, 4:6, 3:7, and the like, provided T_{FNo}=T_{T}+T_{B} and T_{B}≥T_{T}.

Though not wanting to be bound by theory, using less than T_{F} for the thickness of the polymer film(s) in combination with a hard metal substrate, e.g., a metal substrate where the mesh layer cannot be embedded in the metal substrate, a poor bond between the mesh layer, the substrate, and/or the polymer film(s) can result and/or a poor cooking surface can result. When a soft substrate is used, the mesh layer may embed into the substrate. As a result, the substrate will increase in volume due to the embedding of the mesh layer. Further, T_{F}, which is based on the volume of the void space in the mesh layer and where a portion of that void space is now occupied by metal from the metal substrate, could be too large in this scenario. A skilled artisan will understand that, when using a soft substrate where the mesh layer embeds, T_{F} or less may be needed to achieve good bonds and good cooking surface.

The multilayer stacks disclosed herein can be laminated using a pressure fixture or jig 400 depicted in FIG. 4. However, the methods of present disclosure are not limited to a pressure fixture or jig, and any method of applying sufficient pressure can be utilized. The pressure fixture or jig 400 is useful in applying an axial clamping pressure to the one or more multilayer stacks 404 (several multilayer stacks are depicted in FIGS. 2 and 3). The fixture comprises two opposed heavy platens or plates 402 for engaging the respective upper and lower stacks 404 in the array of stacks 404. A plurality of heavy duty bolts 406 are fitted in holes spaced around the periphery of the platens. The bolts have headed portions 408 at one end and opposed threaded ends 410 to receive nuts 412 which, when tightened, force the platens together so as to apply a force in an axial direction, normal to the stacks in the array of stacks 404 situated between the opposed platens 402. Each of the stacks 404 have a solid disc 414 of stainless steel or the like placed therebetween to prevent bonding between the adjacent blank assemblies 404. In one present embodiment, ten bolts 406 are used to apply the bonding pressure. Double nuts 412 may be used at each bolt end to ensure proper strength. After the desired clamping pressure is obtained, the fixture and stacked array are moved to a furnace and heated in a normal atmosphere containing oxygen, a protecting atmosphere, or a vacuum to a desired temperature to achieve the bonding between the individual stacks 404 in the stack array. Alternatively, the stacked array may be heated by an induction heating unit which is positioned adjacent to and around the stacked array so as to avoid heating the fixture 400 to high temperatures as would otherwise occur in a furnace. As mentioned above, in the event more than one multilayered stack 404 is to be bonded, a stainless steel disc 414 or the like is inserted between adjacent stacks 404 to prevent bonding between the adjacent stacks 404.

### EXAMPLE

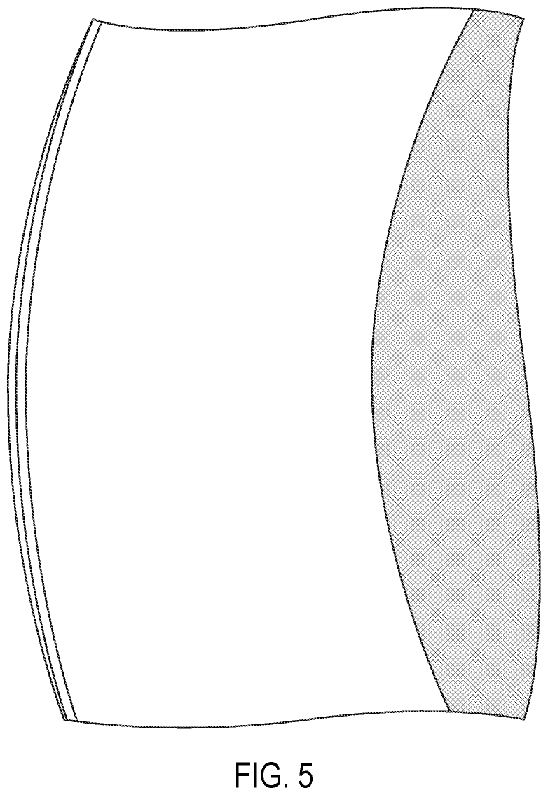

A multilayer stack was manufactured having stainless steel bonded to two sides of an aluminum core, a polytetrafluorethylene film overlying the substrate, a woven mesh (22 wires per inch, 0.0075 in dia., total mesh thickness 0.015 in. overlying the PTFE film, and a second PTFE film overlying the mesh. The diameter of the substrate and the PTFE films was approximately 15 in. The diameter of the mesh was 9 in. The thickness of the PTFE films was 0.0065 in. The thickness of the mesh was 0.015 in. The multilayer stack further included an additional layer having an opening where the layer has an outer diameter equal to that of the substrate and an inner diameter of the opening equal to that of the mesh. The additional layer having the opening has a thickness of 0.002 in. thickness. The multilayer stack was assembled on a jig similar to that depicted in FIG. 4, where a pressure of 500 bar was applied. Once the pressure was applied, the jig and the pressurized multilayer stack was heated at 300° C. for 1 hr. The layer having the opening was removed from the stack after the lamination process was complete. As shown in FIG. 5, the portion of the polymer film extending beyond the diameter of the mesh has a smooth surface.

### Comparative Example

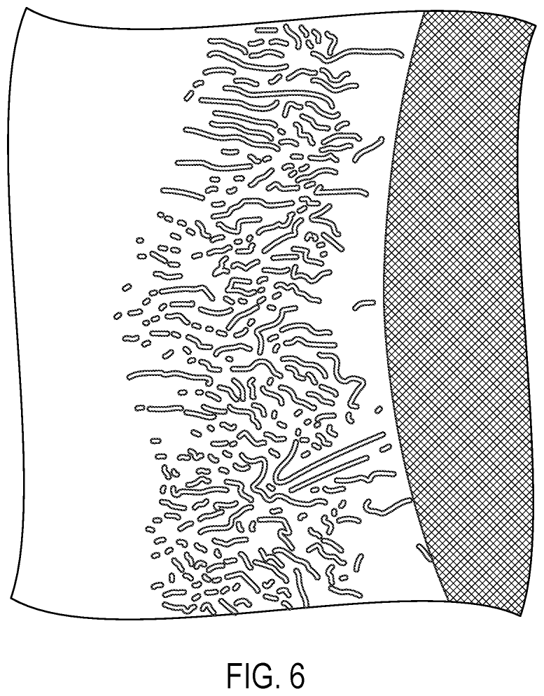

A multilayer stack was manufactured, pressurized and heat under the same conditions in the Example, except the additional layer was omitted. As shown in FIG. 6, the portion of the polymer film extending beyond the diameter of the mesh has an uneven surface.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A cooking utensil, comprising:
a laminate comprising a metal layer, a mesh layer, and a polymer film, where in the mesh layer is embedded in the polymer film,
wherein the laminate is shaped to have a cooking surface and a sidewall surface surrounding the periphery of the cooking surface,
wherein the sidewall surface extends from the periphery of the cooking surface to an outer edge of the laminate,
wherein the mesh layer extends along at least a portion of the sidewall surface, and
wherein a portion of the mesh layer is exposed on the cooking surface and on at least a portion of the sidewall surface.

2. The cooking utensil of claim 1, where the mesh layer does not contact the metal layer.

3. The cooking utensil of claim 1, where the mesh layer contacts the metal layer.

4. The cooking utensil of claim 1, where the mesh layer is partially embedded in the metal layer.

5. The cooking utensil of claim 1, wherein the metal layer further includes a notched portion having the mesh layer disposed therein.

6. The cooking utensil of claim 1, wherein the mesh layer extends along the entire sidewall surface, and where a portion of the mesh is exposed on the sidewall surface.

7. The cooking utensil of claim 6, where the outer edge of the laminate is covered by a cap.

8. The cooking utensil of claim 7, where the mesh layer does not contact the metal layer.

9. The cooking utensil of claim 7, where the mesh layer contacts the metal layer.

10. The cooking utensil of claim 7, where the mesh layer is partially embedded in the metal layer.

11. The cooking utensil of claim 1, wherein the polymer film comprises one or more selected from the group consisting of polytetrafluoroethylene (PTFE), tetrafluoroethylene-hexafluoropropylene copolymer (FEP), tetrafluoroethylene-perfluoroalkyl vinyl ether (PFA), ethylene-tetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE), ethylene-chlorotrifluoroethylene copolymer (ECTEF), PEEK, and PAEK family.

12. The cooking utensil of claim 1, wherein the polymer film is a polytetrafluoroethylene (PTFE) film.

13. The cooking utensil of claim 1, wherein a surface of the metal substrate facing an interior of the multilayer stack comprises at least one of stainless steel, carbon steel, aluminum, or titanium.

14. A cooking utensil, comprising:
a laminate comprising a metal layer, a mesh layer, and a polymer film,
where in the mesh layer is embedded in the polymer film,
wherein the metal layer includes a notch,
wherein the mesh layer is disposed in the notch,
wherein the laminate is shaped to have a cooking surface and a sidewall surface surrounding the periphery of the cooking surface,
wherein the sidewall surface extends from the periphery of the cooking surface to an outer edge of the laminate,
wherein a portion of the mesh layer is exposed on the cooking surface.

15. The cooking utensil of claim 14, wherein the mesh layer does not extend along the sidewall surface.

16. The cooking utensil of claim 14, wherein the mesh layer extends along at least a portion of the sidewall surface and is exposed on the at least a portion of the sidewall surface.

17. The cooking utensil of claim 14, wherein the polymer film comprises one or more selected from the group consisting of polytetrafluoroethylene (PTFE), tetrafluoroethylene-hexafluoropropylene copolymer (FEP), tetrafluoroethylene-perfluoroalkyl vinyl ether (PFA), ethylene-tetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE), ethylene-chlorotrifluoroethylene copolymer (ECTEF), PEEK, and PAEK family.

18. The cooking utensil of claim 14, wherein the polymer film is a polytetrafluoroethylene (PTFE) film.

19. The cooking utensil of claim 14, wherein a surface of the metal substrate facing an interior of the multilayer stack comprises at least one of stainless steel, carbon steel, aluminum, or titanium.

20. A cooking utensil, comprising:
a laminate comprising a metal layer, a mesh layer, an additional layer, and a first polymer film and a second polymer film,
wherein the additional layer has an opening,
wherein the opening surrounds the mesh layer,
wherein the mesh layer and the additional layer are disposed between the first and second polymer films,
wherein the additional layer is a metal or a non-polymer,
wherein the first polymer film and second polymer film contact each other through the mesh layer,
wherein the laminate is shaped to have a cooking surface and a sidewall surface surrounding the periphery of the cooking surface,
wherein the sidewall surface extends from the periphery of the cooking surface to an outer edge of the laminate,
wherein a portion of the mesh layer is exposed on the cooking surface.

21. The cooking utensil of claim 20, wherein the first and second polymer films comprises one or more selected from the group consisting of polytetrafluoroethylene (PTFE), tetrafluoroethylene-hexafluoropropylene copolymer (FEP), tetrafluoroethylene-perfluoroalkyl vinyl ether (PFA), ethylene-tetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE), ethylene-chlorotrifluoroethylene copolymer (ECTEF), PEEK, and PAEK family.

22. The cooking utensil of claim 20, wherein the first and second polymer films are a polytetrafluoroethylene (PTFE) film.

23. The cooking utensil of claim 20, wherein a surface of the metal substrate facing an interior of the multilayer stack comprises at least one of stainless steel, carbon steel, aluminum, or titanium.

24. The cooking utensil of claim 20, where the mesh layer does not contact the metal layer.

25. The cooking utensil of claim 20, where the mesh layer contacts the metal layer.

26. The cooking utensil of claim 20, where the mesh layer is partially embedded in the metal layer.
